(19) United States
(12) Patent Application Publication
(10) Pub. No.: US 2010/0332622 A1
(43) Pub. Date: Dec. 30, 2010

(54) Distributed Resource and Service Management System and Method for Managing Distributed Resources and Services

(75) Inventors: Jason Thomas Carolan, Denver, CO (US); Jan Mikael Markus Loefstrand, Sandenvaegen (SE); Robert Thurstan Edwin Holt, San Francisco, CA (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/491,362

(22) Filed: Jun. 25, 2009

(51) Int. Cl. G06F 15/177; G06F 15/173

(52) U.S. Cl. 709/220; 709/226; 709/224

(57) ABSTRACT

A distributed resource and service management system includes at least one node and a registry service. The at least one node is configured to execute at least one node controller. The registry service is configured to provide at least one service description via a control interface, and to offer logical resources to the at least one node controller. The at least one node controller is configured to discover the registry service, to initiate on-going communications with the registry service, and to execute at least one of queries, updates and inserts to the registry service to maintain service levels.

### BACKGROUND

### Sun Grid Engine, Enterprise Edition 5.3

A grid is a collection of computing resources that perform tasks. In its simplest form, a grid appears to users as a large system that provides a single point of access to powerful distributed resources. In more complex forms, grids can provide many access points to users. In any case, users treat the grid as a single computational resource. Resource management software accepts jobs submitted by users and schedules them for execution on appropriate systems in the grid based upon resource management policies. Users can submit literally millions of jobs at a time without being concerned about where they run. There are three key classes of grids, which scale from single systems to supercomputer-class compute farms that utilize thousands of processors.

A user who submits a job through the Sun Grid Engine, Enterprise Edition system declares a requirement profile for the job. In addition, the identity of the user and his or her affiliation with projects or user groups is retrieved by the system. The time that the user submitted the job is also stored. The moment, literally, that a queue is scheduled to be available for execution of a new job, the Sun Grid Engine, Enterprise Edition system determines suitable jobs for the queue and immediately dispatches the job with the highest priority or longest waiting time. Sun Grid Engine, Enterprise Edition queues may allow concurrent execution of many jobs. The Sun Grid Engine, Enterprise Edition system will try to start new jobs in the least loaded and suitable queue.

Four types of hosts are fundamental to the Sun Grid Engine, Enterprise Edition system: Master, Execution, Administration, and Submit. The master host is central for the overall cluster activity. It runs the master daemon, sge_qmaster, and the scheduler daemon, sge_schedd. Both daemons control all Sun Grid Engine, Enterprise Edition components, such as queues and jobs, and maintain tables about the status of the components, about user access permissions, and the like. By default, the master host is also an administration host and submit host.

Execution hosts are nodes that have permission to execute Sun Grid Engine, Enterprise Edition jobs. Therefore, they are hosting Sun Grid Engine, Enterprise Edition queues and run the Sun Grid Engine, Enterprise Edition execution daemon, sge_execd.

Permission can be given to hosts to carry out any kind of administrative activity for the Sun Grid Engine, Enterprise Edition system.

Submit hosts allow for submitting and controlling batch jobs only. In particular, a user who is logged into a submit host can submit jobs via qsub, can control the job status via qstat, and can use the Sun Grid Engine, Enterprise Edition OSF/1 Motif graphical user interface, QMON.

A batch job is a UNIX shell script that can be executed without user intervention and does not require access to a terminal. An interactive job is a session started with the Sun Grid Engine, Enterprise Edition commands, qrsh, qsh, or qlogin that will open an xterm window for user interaction or provide the equivalent of a remote login session, respectively.

### Hedeby

Hedeby is a Service Domain Management system which makes it possible to manage scalable services. This project is developed by the Sun Grid Engine Management Team. As with the Sun Grid Engine project, the Hedeby project has also been open sourced under SISSL license (http://hedeby.sunsource.net/license.html). The Service Domain Manager is designed to handle very different kinds of services. The main purpose is solving resources lacking of such services. Hedeby is interesting for all administrators managing huge services with an administration interface. The Service Domain Manager will be able to detect scalability problems and resolve them. For the first release, the Hedeby team will concentrate on using Hedeby to manage the Sun Grid Engine service.

A service in the term of Hedeby is a piece of software. It can be a database, an application server or any other software. The only constraint is that the software has to provide a service management interface. To make a service manageable, Hedeby needs a driver for the service. Such a driver is called a service adapter. The service adapter is packaged in a jar file. It has its own configuration and, in the current version, runs inside a service container.

On the master host, Hedeby will install three processes (Java processes). The cs_vm with the configuration service component, rp_vm with the Resource Provider, Eeporter and Spare Pool component, and executor_vm with the executor and the CA component. cs_vm and rp_vm will run as sdm_admin user. executor_vm is started as user root.

The CA component of Hedeby use Grid Engine's sge_ca script for managing the certificate authority. As a consequence, the Hedeby master host needs access to a Grid Engine 6.2 SGE_ROOT directory.

### Solaris Zones

The Solaris Zones partitioning technology may be used to virtualize OS services and provide an isolated and secure environment for running applications. A zone is a virtualized OS environment created within a single instance of the Solaris OS. When a zone is created, an application execution environment is produced in which processes are isolated from the rest of the system. This isolation prevents processes that are running in one zone from monitoring or affecting processes that are running in other zones. Even a process running with superuser credentials cannot view or affect activity in other zones.

A zone may also provide an abstract layer that separates applications from the physical attributes of the machine on which they are deployed. An example of these attributes include physical device paths.

In certain circumstances, the upper limit for the number of zones on a system is 8,192. The number of zones, however, that may be effectively hosted on a single system is determined, for example, by the total resource requirements of the application SW running in all of the zones.

Zones may be ideal for environments that consolidate a number of applications on a single server. The cost and complexity of managing numerous machines may make it advantageous to consolidate several applications on larger, more scalable servers.

Zones may enable more efficient resource utilization on a system. Dynamic resource reallocation permits unused resources to be shifted to other containers as needed. Fault and security isolation mean that poorly behaved applications do not require a dedicated and under-utilized system. With the use of zones, these applications can be consolidated with other applications.

Zones may allow the delegation of some administrative functions while maintaining overall system security.

A non-global zone may be thought of as a box. One or more applications may run in this box without interacting with the rest of the system. Solaris zones isolate software applications or services by using flexible, SW-defined boundaries. Applications that are running in the same instance of the Solaris OS may then be managed independently of one other. Thus, different versions of the same application may be run in different zones to match the requirements of the desired configuration.

A process assigned to a zone may manipulate, monitor and directly communicate with other processes that are assigned to the same zone. The process cannot perform these functions with processes that are assigned to other zones in the system or with processes that are not assigned to a zone. Processes that are assigned to different zones are able to communicate through network APIs.

Solaris systems may contain a global zone. The global zone may have a dual function. The global zone may be both the default zone for the system and the zone used for system-wide administrative control. All processes may run in the global zone if no non-global zones, referred to sometimes as simply zones, are created by a global administrator.

The global zone may be the zone from which a non-global zone may be configured, installed, managed or uninstalled. The global zone may be bootable from the system hardware. Administration of the system infrastructure, such as physical devices, routing in a shared-IP zone or dynamic reconfiguration may only be possible in the global zone.

The global administrator may use the “zonecfg” command to configure a zone by specifying various parameters for the zone's virtual platform and application environment. The zone is then installed by the global administrator, who uses the zone administration command “zoneadm” to install SW at the package level into the file system hierarchy established for the zone. The global administrator may log into the installed zone by using the “zlogin” command. At first login, the internal configuration for the zone is completed. The “zoneadm” command is then used to boot the zone.

### SUMMARY

A distributed resource and service management system includes at least one node and a registry service. The at least one node is configured to execute at least one node controller. The registry service is configured to provide at least one service description via a control interface, and to offer logical resources to the at least one node controller. The at least one node controller is configured to discover the registry service, to initiate on-going communications with the registry service, and to execute at least one of queries, updates and inserts to the registry service to maintain service levels.

A method for managing distributed resources and services via at least one node executing at least one node controller includes discovering a registry service configured to provide at least one service description via a control interface, and to offer logical resources to the at least one node controller, initiating on-going communications with the registry service, and executing at least one of queries, updates and inserts to the registry service to maintain service levels. The method also includes at least one of allocating, deallocating, tracking and configuring resources assigned to the at least one node based on the queries, observing health of other node controllers, and updating the registry service based on the observed health of the other node controllers.

A distributed resource and service management system includes at least one node and a registry service. The at least one node is configured to execute at least one node controller. The registry service is configured to provide at least one service description via a control interface, and to offer logical resources to the at least one node controller. The at least one node controller is configured to discover the registry service, to initiate on-going communications with the registry service, to observe health of other node controllers, and to update the registry service based on the observed health of the other node controllers.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1 is a block diagram of an embodiment of a distributed resource and service management system, and shows, inter alia, a node controller installed and running on a server at several instances of time.

FIG. 2 is a sequence diagram illustrating communications between a node controller, DSC registry, and node.

FIG. 3 is a sequence diagram illustrating communications between several node controllers and a DSC registry.

### DETAILED DESCRIPTION

Scalable service management across multiple computers may be challenging. Current systems, such as Grid Engine and Hedeby, and enterprise software products like Tivoli or N1 SPS, use a single node “push” model where an admin or automation tool pushes applications on to a system where they live for some period of time-without regard to service level management beyond whether the job has completed, or the knowledge about service health and capabilities of the resources for dynamic consumption. Additionally, these technologies may not be integrated, and may require large SW framework purchases to implement.

Certain embodiments described herein may embed distributed management into a base OS with limited centralized service knowledge, and implement self-managing intelligent nodes and simple workload encapsulation and packaging. Example solutions may provide a model to provision scalable applications across Solaris nodes (or any other OS) using concepts and features such as SMF and FMA. Some solutions extend the global zone SMF concept by monitoring zone-based (client) processes that may include payload or workload, which is monitored by SMF location and a daemon that allows SMF to communicate over the network to provide and receive service information. Components of these solutions may include a client node (running, for example, dynamic service containers (DSC) daemon), a DSC registry, and a SW repository than includes packages, files, etc.

In one example, a server comes online and effectively asks the registry “what can I do?” If the registry has workloads that need to be run, a node starts to process this request. The node may provision itself based on this limited context provided by the registry. The registry, in certain circumstances, may provide only the bootstrap data for the service and some metrics around service levels. Nodes may be responsible for taking care of themselves and reporting their (and their neighbors') state.

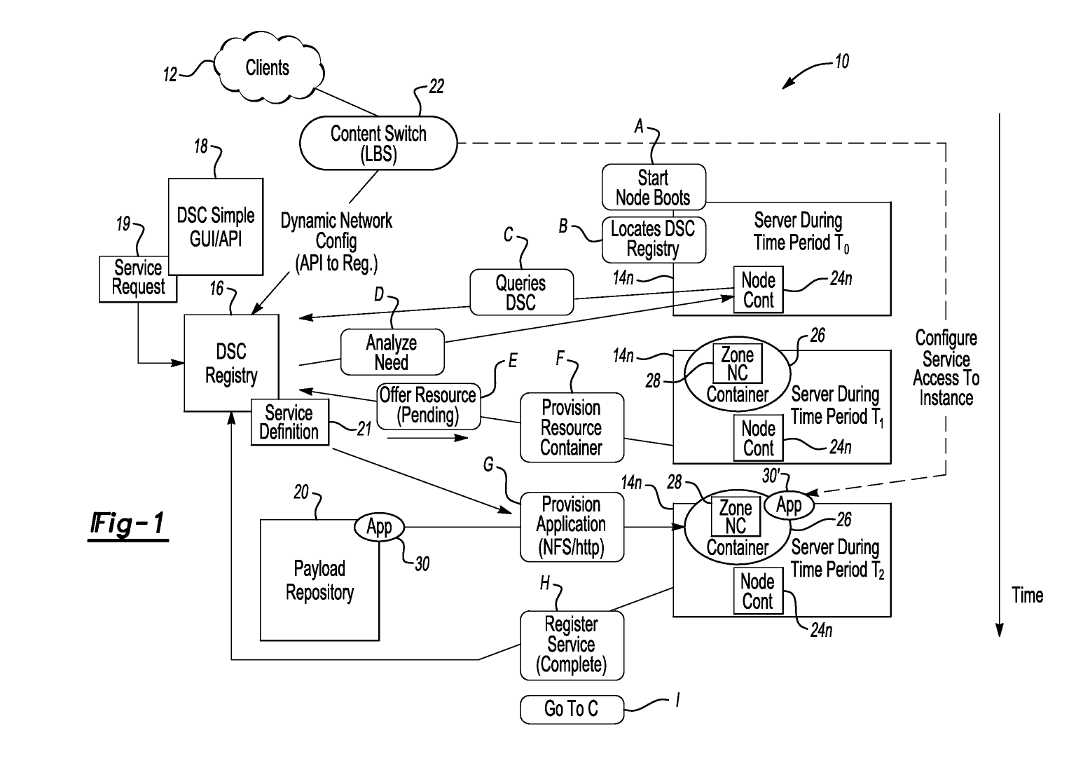

Referring now to FIG. 1, an embodiment of a distributed resource and service management system 10 for one or more clients 12 may include at least one server 14n, a DSC registry 16 (that is online), a DSC simple GUI/API 18, a payload repository 20 (with defined payloads), and a content switch 22. A user, e.g., person or another system, via the GUI/API 18 may specify a new service request 19 to be run and managed via the system 10. The service request 19 is then decomposed into one or more service elements or service element descriptions 21. The at least one server 14n of FIG. 1 has a DSC node controller 24n installed and running.

As known in the art, DSC are an Open Source and OpenSolaris Project built using OpenSolaris, MySQL, BASH, PHP, etc. They offer a set of software to manage scalable application deployment and service level management leveraging virtualized environments. DSC may allow the continuous policy-based automated deployment of payloads across nodes in a highly decentralized model, and leverage network content load balancing, service level monitoring, etc. to allow dynamic scaling.

As indicated at “A,” the node controller 24n (already installed) runs at startup. As indicated at “B,” the node controller 24n may locate the DSC registry 16 via, for example, hard coding techniques, e.g., using an IP address or name resolution, or a service discovery protocol, also known as ZeroConf technologies. A node may thus be specified as belonging to a particular domain that restricts its level of responsibility. As indicated at “C,” the node controller 24n may query the DSC registry 16 to pull initial configuration parameters (first time event) and apply those configuration parameters to itself, to determine if its controller software is up to date, and to subsequently query for unmet/unsatisfied service definitions, e.g., a user supplying new service requests or a change detected in a previously defined service. The node controller 24n, in this example, is reaching out to the DSC registry 16 and asking “Am I up to date? . . . Are there any services that have yet to be hosted ?, etc.” As indicated at “D,” the node controller 24n may analyze the results it receives to determine its suitability to host the workloads, e.g., does it have the correct processor architecture?, is the current # of instances≧min instances and<max instances?

As a result of the above, the server 14n now has a container 26 and zone node controller 28 installed (by, for example, copying the server node controller 24n to the zone 26) and running. As indicated at “E,” the node controller 24n may offer to host the workload and “locks” in progress state into the DSC registry 16 for service definition. As indicated at “F,” the node controller 24n may begin the provisioning process on the sever 14n, e.g., the node controller 24n takes additional data from the registry, such as the software registry location and the URL, and begins the provisioning process.

As indicated at “G,” the node controller 24n may locate the software repository 20 via the URL provided by the DSC registry 16, pull workloads 30, and execute, for example, the workload install.sh within the payload bundles. The resulting application 30′ is then running on/within the zone 26. As indicated at “H,” the node controller 24n may start the service and register the service back with the DSC registry 16 (it may notify the DSC registry 16 that it has completed the process.) As indicated at “I,” the process may then restart by returning to “C.”

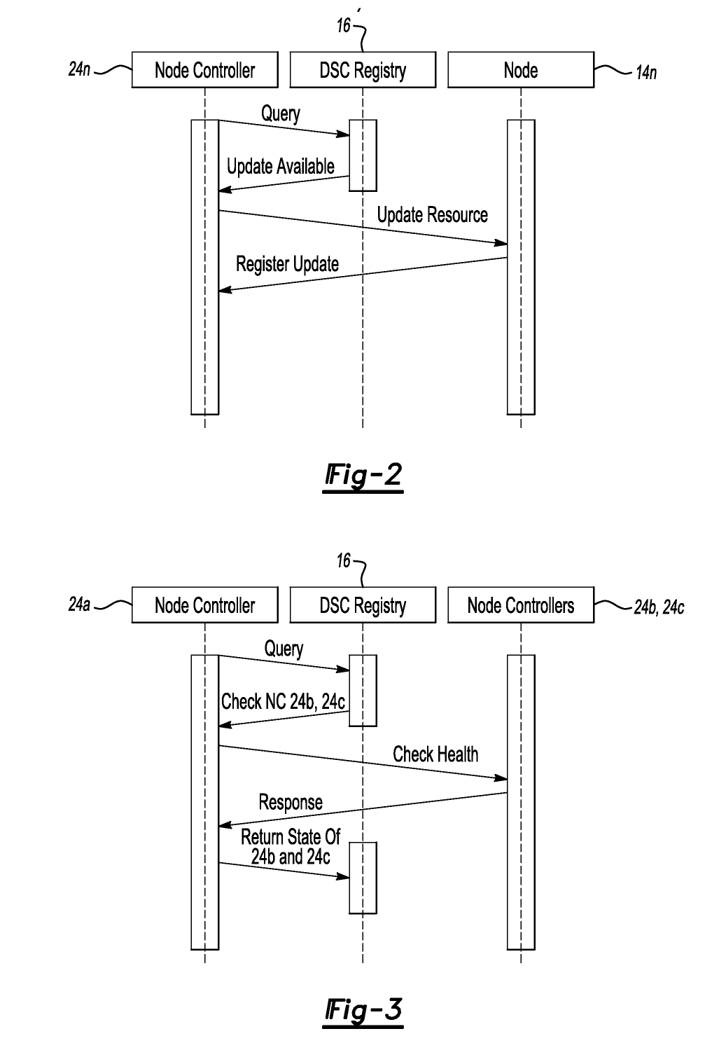

Referring now to FIG. 2, the node controller 24n queries the DSC registry 16, analyzes tables on the DSC registry 16, and determines if there are any updates available. If so, the node controller 24n may execute some additional business logic and update the node 14n. The node 14n may then communicate back to the node controller 24n that the update is complete.

Referring now to FIG. 3, the node controller 24a may query the DSC registry 16 for node controller information so that it may determine using, for example, a hashing algorithm, the identify of its closest logical node controller neighbors, e.g., node controllers 24b, 24c. The node controller 24a may then check the health of the node controllers 24b, 24c. The node controller 24a may, for example, check to see if it can reach the node controllers 24b, 24c via, for example, a TCP connection check between the node controller 24a and the node controllers 24b, 24c. The node controller 24a may also check the health of the application 30′ on, for example, node controllers 24b, 24c, the health of the registry 16, etc. and act accordingly. The node controller 24a may then verify, via a check sum for example, the node controllers 24b, 24c with the DSC registry 16. The node controller 24a may then return the state of the node controllers 24b, 24c to the DSC registry 16. Other scenarios are also possible.

While embodiments of the invention have been illustrated and described, it is not intended that these embodiments illustrate and describe all possible forms of the invention. Certain embodiments have been discussed with reference to Solaris zones. Those of ordinary skill, however, will recognize that other embodiments may be implemented within other contexts, such as logical domains and/or other types of hypervisors, or other types of nodes, for example, nodes acting as network devices versus general “compute” servers. The words used in the specification are words of description rather than limitation, and it is understood that various changes may be made without departing from the spirit and scope of the invention.

What is claimed is:

1. A distributed resource and service management system comprising:
at least one node configured to execute at least one node controller; and
a registry service configured to provide at least one service description via a control interface, and to offer logical resources to the at least one node controller, wherein the at least one node controller is configured to (i) discover the registry service, (ii) initiate on-going communications with the registry service, and (iii) execute at least one of queries, updates and inserts to the registry service to maintain service levels.

2. The system of claim 1 wherein the at least one node controller is further configured to at least one of allocate, deallocate, track and configure resources assigned to the at least one node based on the queries.

3. The system of claim 1 wherein the at least one node controller is further configured to observe health of other node controllers.

4. The system of claim 3 wherein the at least one node controller is further configured to update the registry service based on the observed health of the other node controllers.

5. The system of claim 1 wherein the at least one node controller is further configured to report at least one of distributed resource and service status, and node status to the registry service.

6. The system of claim 5 wherein the at least one node controller is further configured to alter resources assigned to the at least one node based on the distributed resource and service status, or the node status

7. The system of claim 1 further comprising at least one payload repository configured to store workloads for the logical resources offered to the at least one node controller.

8. The system of claim 7 wherein the at least one payload repository is further configured to store workload metadata.

9. The system of claim 8 wherein the at least one node controller is further configured to pull the workloads from the at least one payload repository.

10. The system of claim 9 wherein the pulled workloads are configured to install and run upon deployment by the at least one node controller.

11. The system of claim 1 wherein the registry service is further configured to track logical resources assigned to the at least one node.

12. A method for managing distributed resources and services via at least one node executing at least one node controller, the method comprising:
discovering, at one or more computers, a registry service configured to provide at least one service description via a control interface, and to offer logical resources to the at least one node controller;
initiating on-going communications with the registry service;
executing at least one of queries, updates and inserts to the registry service to maintain service levels;
at least one of allocating, deallocating, tracking and configuring resources assigned to the at least one node based on the queries;
observing health of other node controllers; and
updating the registry service based on the observed health of the other node controllers.

13. The method of claim 12 further comprising reporting at least one of distributed resource and service status, and node status to the registry service.

14. The method of claim 13 further comprising altering the resources assigned to the at least one node based on the distributed resource and service status, or the node status

15. The method of claim 12 further comprising pulling workloads from at least one payload repository.

16. The method of claim 12 wherein the registry service is further configured to track logical resources assigned to the at least one node.

17. A distributed resource and service management system comprising:
at least one node configured to execute at least one node controller; and
a registry service configured to provide at least one service description via a control interface, and to offer logical resources to the at least one node controller, wherein the at least one node controller is configured to (i) discover the registry service, (ii) initiate on-going communications with the registry service, (iii) observe health of other node controllers, and (iv) update the registry service based on the observed health of the other node controllers.

18. The system of claim 17 wherein the at least one node controller is further configured to execute at least one of queries, updates and inserts to the registry service to maintain service levels.

19. The system of claim 18 wherein the at least one node controller is further configured to at least one of allocate, deallocate, track and configure resources assigned to the at least one node based on the queries.
